(19) United States
(12) Patent Application Publication
(10) Pub. No.: US 2008/0047778 A1
(43) Pub. Date: Feb. 28, 2008

(54) Exhaust end structure of a straight pneumatic wrench

(75) Inventor: Hsin-Chi Chen, Taiping City (TW)

Correspondence Address: TROXELL LAW OFFICE PLLC, SUITE 1404, 5205 LEESBURG PIKE, FALLS CHURCH, VA, 22041, US

(73) Assignee: Tranmax Machinery Co., Ltd.

(21) Appl. No.: 11/486,316

(22) Filed: Jul. 14, 2006

(30) Foreign Application Priority Data
May 19, 2006 (TW) 095208710

(51) Int. Cl. G10K 11/00

(52) U.S. Cl. 181/175

(57) ABSTRACT

An exhaust end structure of a straight pneumatic wrench, including: a main body having a housing, at least one exhaust ports being formed on a wall of the housing for communicating an internal exhaust passage of the housing with outer atmosphere; and a tubular guide member, a first end of the guide member being connected with a section of the housing around the exhaust ports, whereby the exhaust ports only communicate with an interior of the tubular guide member.

### BACKGROUND OF THE INVENTION

The present invention is related to a pneumatic tool, and more particularly to an improved exhaust end structure of a straight pneumatic wrench.

In the conventional pneumatic tool, external compressed gas is guided through an intake passage into an internal pneumatic cylinder of the pneumatic tool to drive the rotor. The rotor then outputs power for driving a work piece. The gas is then guided through an exhaust passage and exhausted from the pneumatic tool.

FIG. 1 shows a conventional straight pneumatic wrench 1 having housing 2 formed with several through holes 3. The through holes 3 communicate the internal gas passage of the housing with the outer side of the housing, whereby the gas can be exhausted from the housing 2 through the through holes 3.

According to the above structure of the exhaust end of the conventional straight pneumatic wrench 1, the exhausted gas is not well treated. Therefore, the exhaust gas still has a pressure higher than that of the atmosphere and thus will flow at a higher speed. Accordingly, the gas exhausted at high speed will directly impact a worker or a work piece in the environment. As a result, the dusts will fly around to pollute the air and cause harm to the health of the respiration system of the worker. In addition, the through holes of the housing are too close to the operation components inside the housing of the pneumatic tool. Therefore, the knocking sound of the operation components tends to be emitted to outer side. In operation of the straight pneumatic wrench, a great noise is produced to harm the auricular system of a worker.

### SUMMARY OF THE INVENTION

It is therefore a primary object of the present invention to provide an improved exhaust end structure of a straight pneumatic wrench. The exhaust end structure includes a guide member for guiding the exhausted gas in a direction away from the operator and the work piece. This minimizes the possibility of accident in the working site and reduces the pollution of environment. Moreover, The operational noise is prevented from being directly emitted through the exhaust ports. Therefore, the guide member also serves to achieve a certain muffling effect.

According to the above object, the exhaust end structure of the straight pneumatic wrench of the present invention includes: a main body having a housing, at least one exhaust ports being formed on a wall of the housing for communicating an internal exhaust passage of the housing with outer atmosphere; and a tubular guide member, a first end of the guide member being connected with a section of the housing around the exhaust ports, whereby the exhaust ports only communicate with an interior of the tubular guide member.

The present invention can be best understood through the following description and accompanying drawings wherein:

### BRIEF DESCRIPTION OF THE DRAWINGS

FIG. 1 is a perspective assembled view of a conventional straight pneumatic wrench;

FIG. 2 is a perspective assembled view of a preferred embodiment of the present invention;

FIG. 3 is a perspective exploded view of the preferred embodiment of the present invention;

FIG. 4 is a side view of the preferred embodiment of the present invention;

FIG. 5 is a partially sectional view taken along line 5-5 of FIG. 4; and

FIG. 6 is a perspective view of the tubular guide member of the preferred embodiment of the present invention.

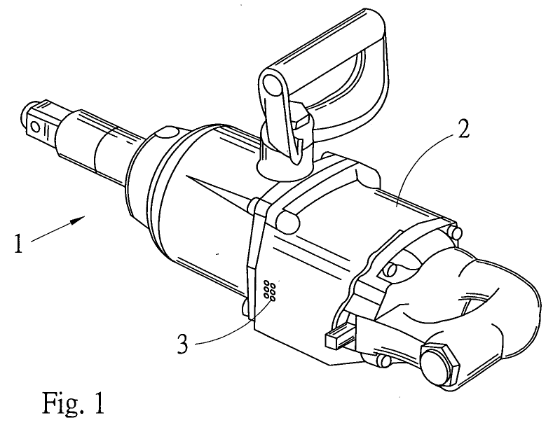

### DETAILED DESCRIPTION OF THE PREFERRED EMBODIMENTS

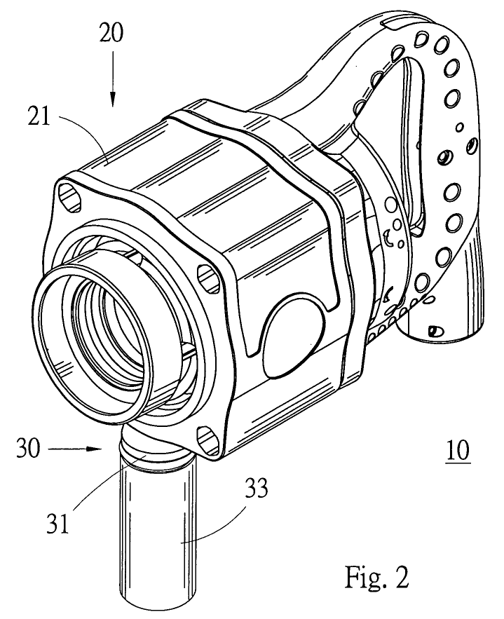

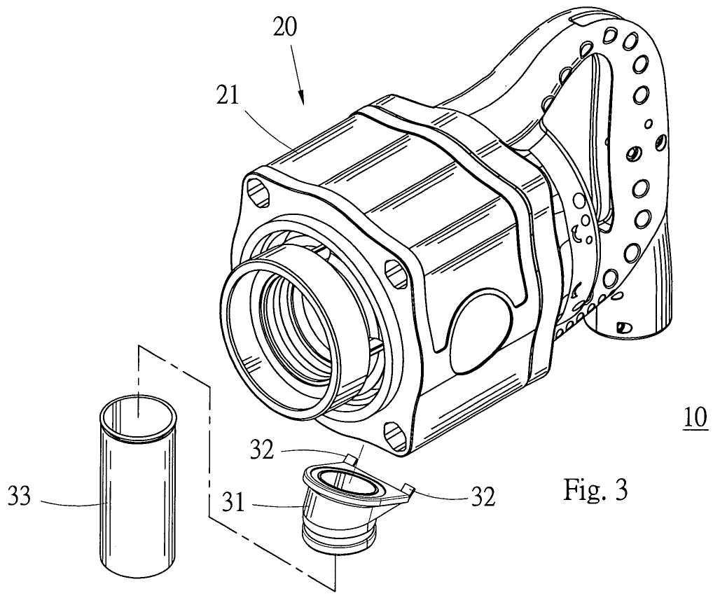

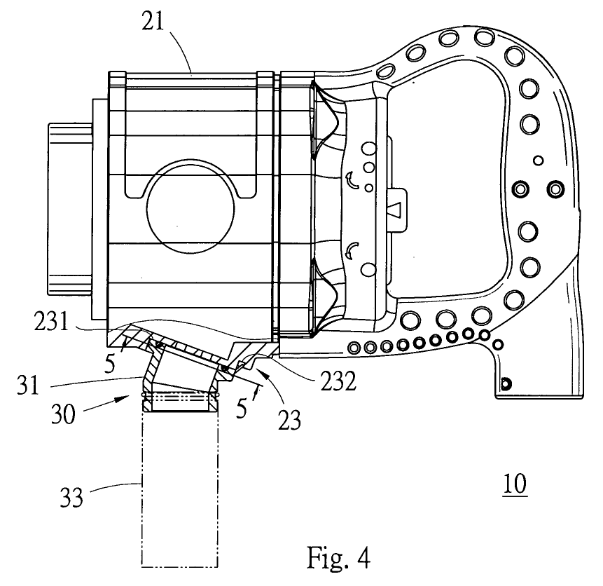

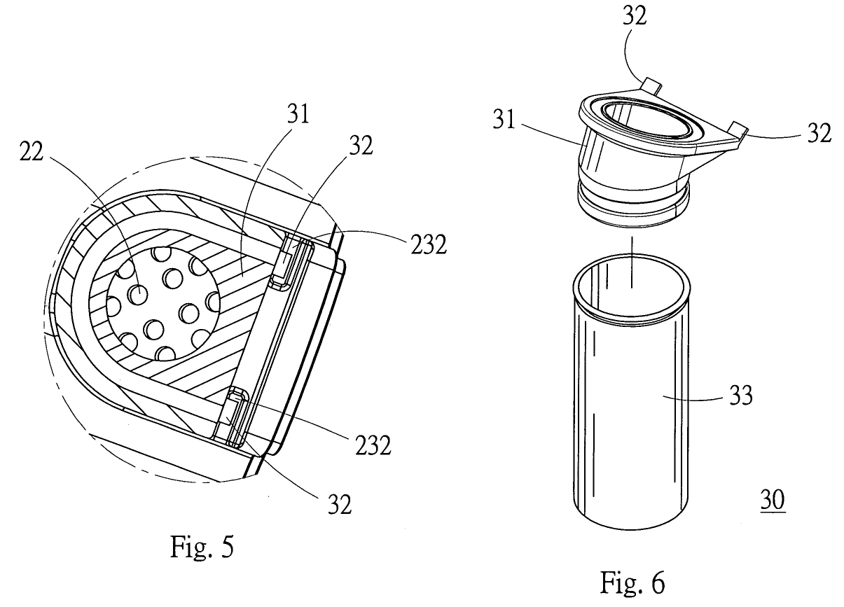

Please refer to FIGS. 2 to 6. The exhaust end structure 10 of the straight pneumatic wrench of the present invention includes a main body 20 and a guide member 30.

The main body 20 has a configuration similar to that of prior art. The main body 20 has a housing 21. Several exhaust ports 22 are formed on a bottom wall of the housing 21 for communicating an internal exhaust passage of the housing 21 with the outer atmosphere. The main body 20 further has an engaging section 23. The engaging section 23 has a hollow projecting block 231 protruding from the bottom of the housing 21 to form an obliquely retracted end face. The exhaust ports 22 are formed on the obliquely retracted end face. Two symmetrical engaging slots 232 are disposed on one side of the projecting block 231.

The guide member 30 includes a bighted end cap 31. A first end of the end cap 31 is inserted with the obliquely retracted end face of the projecting block 231. The end cap 31 has two symmetrical resilient engaging tongues 32 respectively extending from outer circumference of the end cap 31 corresponding to the engaging slots 232. The engaging tongues 32 are respectively engaged in the engaging slots 232 to locate the first end of the end cap 31 on the projecting block 231. The guide member 30 further includes an extension tube 33 with a certain length. A first end of the extension tube 33 is axially serially connected with a second end of the end cap 31.

According to the above arrangement, when the compressed gas goes through the internal exhaust passage of the straight pneumatic wrench to the exhaust ports 22, the compressed gas is restricted and guided by the guide member 30 to only escape from a second end of the extension tube 33 to the atmosphere. Accordingly, by means of the guide member 30, the exhausted gas is guided in a direction away from the operator and the work piece. This minimizes the possibility of accident in the working site and reduces the pollution of environment. Moreover, The operational noise is prevented from being directly emitted through the exhaust ports 22. Therefore, the guide member 30 serves to achieve a certain muffling effect.

Alternatively, the guide member 30 can be one single flexible tube. One end of the flexible tube is directly fixedly connected with a section of the housing around the exhaust ports 22. In other words, the guide member 30 can be any tubular conduit with a certain length for guiding the exhausted gas to a certain position outside the housing of the straight pneumatic wrench. The guide member can prevent the gas from directly impacting a worker or a work piece. Also, the guide member can lower the noise.

The above embodiments are only used to illustrate the present invention, not intended to limit the scope thereof. Many modifications of the above embodiments can be made without departing from the spirit of the present invention.

What is claimed is:

1. An exhaust end structure of a straight pneumatic wrench, comprising:
a main body having a housing, at least one exhaust ports being formed on a wall of the housing for communicating an internal exhaust passage of the housing with outer atmosphere; and
a tubular guide member, a first end of the guide member being connected with a section of the housing around the exhaust ports, whereby the exhaust ports only communicate with an interior of the tubular guide member.

2. The exhaust end structure of the straight pneumatic wrench as claimed in claim 1, wherein the guide member includes a tubular end cap, a first end of the end cap being connected with a section of the housing around the exhaust ports, the guide member further includes an extension tube with a predetermined length, a first end of the extension tube being serially connected with a second end of the end cap.

3. The exhaust end structure of the straight pneumatic wrench as claimed in claim 2, wherein the end cap has two ends each having an opening, the axes of the openings of the two ends of the end cap containing a predetermined angle.
